(19) United States
(12) Patent Application Publication
(10) Pub. No.: US 2009/0232979 A1
(43) Pub. Date: Sep. 17, 2009

(54) Pigment-Colored Latex and Method for Treating a Clear Substrate with Said Colored Latex

(75) Inventors: Pascale Tardieu, Paris (FR); Sylvette Maisonnier, Auzay (FR); Anne Robert, Villecresne (FR)

Correspondence Address: FULBRIGHT & JAWORSKI L.L.P., 600 CONGRESS AVE., SUITE 2400, AUSTIN, TX, 78701, US

(73) Assignee: Essilor International Compagnie d'Optique, Charenton cedex (FR)

(21) Appl. No.: 10/599,975

(22) PCT Filed: Apr. 15, 2005
(86) PCT No.: PCT/FR05/50247

§ 371 Date: Dec. 1, 2008

(30) Foreign Application Priority Data
Apr. 16, 2004 (FR) 0404068
May 18, 2004 (FR) 0450988

(51) Int. Cl. B05D 5/06; C08K 5/3417; G02C 7/02; G02B 1/10

(52) U.S. Cl. 427/164; 524/88; 351/163

(57) ABSTRACT

The invention is dedicated to a colored latex comprising a mixture of an uncolored initial latex and at least one initial aqueous dispersion of at least one pigment being under the form of particles, wherein the particles of the pigment(s) are water-insoluble, and an amount of at least 90% of the particles of the one or more pigment(s) have a particle size of 370 nm or less, in the initial aqueous dispersion.

The invention also relates to a process for preparing such colored latex and an ophthalmic lens coated with a layer of such colored latex.

The present invention generally relates to a colored latex, a method for producing such a colored latex, a method for treating a transparent substrate, especially made of organic glass, using said colored latex, as well as an ophthalmic lens comprising a substrate coated with a layer of said colored latex.

The most usual method for coloring organic glasses in the opthalmologic field consists in dipping these organic glasses into an aqueous coloring bath comprising pigments that are solubilized and/or dispersed therein, such bath being generally maintained close to the boiling temperature (typically at a temperature ranging from approx. 90 to 95° C.). Pigments then diffuse under the substrate's surface and the color density is obtained due to a certain amount of pigments having superficially entered into the substrate.

These coloring procedures are complicated since they depend on the affinity between the pigment and the material that forms the substrate.

Seeing that ophthalmic glasses are made of a plurality of substrates that are different in nature, the method for treating each of them has to be continually adapted, which is expensive in terms of time and labour devoted to that task. This is made even more difficult when some colors are expected, that do require many pigments to penetrate, and many retouching operations are then needed, that are conducted after a visual evaluation by the operators.

Moreover, some substrates, such as those based on polycarbonates (PC), are very difficult to color on that way. It is then necessary to add solvents to the coloring bath, that are able to partially dissolve or to superficially swell the polycarbonate, so as to enable the pigment to penetrate under the substrate's surface.

However these solvents are often aggressive for the surface of the treated substrates. Additionally, considering the international directives aiming at reducing the use of organic solvents, such methods should suitably be avoided.

A colored latex is known from the U.S. Pat. No. 5,977,210, and especially a method for preparing an ink in the form of a colored latex, comprising the steps consisting in preparing a latex, adding to this latex a pigment coming as an aqueous suspension together with a cationic surfactant, and adding an anionic surfactant to prevent the mixture from clustering.

However, nothing is mentioned about the ophthalmic use of colored latexes.

It is therefore an objective of the present invention to provide a colored latex, a method for producing such colored latex, as well as a method for treating a transparent substrate, especially made of organic glass, using said colored latex, so as to overcome the drawbacks of the prior art.

Transparent substrates include photochromic substrates, those that become colored upon exposure to an ultraviolet light, and those that are uncolored, or that are very slightly colored without any ultraviolet light.

The method for treating a transparent substrate should make it possible to produce colored glasses, obtainable on prescription or on request of the customer/patient, having an intense coloration, that may especially reach a relative light transmission factor in the visible spectrum (Tv) of less than 20%, while preserving excellent optical properties, in particular without diffusing.

Relative Light Transmission Factor in the Visible Spectrum (Tv):

As already known from the person skilled in the art, this factor is specific to ophthalmic optics: it does sum up the physiological properties of the filter in one number, which corresponds to the ratio of the luminous flux emerging from the glass to the incident luminous flux falling onto the glass, as perceived by the eye, that is to say weighted for each wavelength by the spectral luminous efficiency V_{λ} of the eye. This factor is calculated according to the following formula:

$${T}_{v} = \frac{{\int }_{380}^{780} {Φ}_{λ} {T}_{λ} {V}_{λ} {d}_{λ}}{{\int }_{380}^{780} {Φ}_{λ} {V}_{λ} {d}_{λ}}$$

wherein T_{λ}=spectral transmittance, Φ₈₀ =incident spectral flux, V_{λ}=photopic spectral luminous efficiency of the eye. This is that coefficient Tv that is used for sunglass description and classification.

Coloring the substrates by means of the colored latex should be obtained without fundamentally modifying the ordinary deposition methods, especially the deposition of the following layers, notably anti-abrasion and antireflective coatings, that should maintain a good adhesion on the substrate, on the colored latex or between each other.

The colored glasses that are obtained should present an excellent resistance to abrasion and a good impact resistance.

They also should present a good resistance to ageing. Colored glasses should especially not undergo any light ageing, or as little as possible.

The colored latex layer should resist to dipping into a 5% soda solution without dissolving itself, without releasing pigments and without loss of its optical or physical properties.

Finally, the colored latex properties should not be altered by vacuum deposition treatments, especially antireflective treatments.

It is therefore the first objective of the present invention to provide a colored latex comprising a mixture of an uncolored initial latex and at least one initial aqueous dispersion of at least one pigment. According to the invention:
the one or more pigment(s) is or are water-insoluble, and
at least X % of the particles of the one or more pigment(s) have a particle size L that is 370 nm or less, preferably 350 nm or less, more preferably 320 nm or less, even more preferably 280 nm, or less, X being equal to 90.

Preferably, the pigment particle mean size in the initial aqueous dispersion is less than 200 nm, more preferably less than 150 nm, even more preferably less than 100 nm.

Preferably, the particle % amount X of the one or more pigment(s) having a size L is 95%, more preferably 97%, even more preferably 99% and most preferably 100%.

Usually, the particle size, when the particle is spherical in form, means the diameter of such particle and when the particle is not spherical in form, means the greatest length of the same.

Any type of latex may be used as the uncolored initial latex.

As is well known, latexes are polymer dispersions in an aqueous phase, for example a water-alcohol phase.

The uncolored initial latex may be a latex based on (meth)acrylic polymers, on polyurethanes, on polyesters, on styrene/(meth)acrylate copolymers, or on butadiene/(meth)acrylate copolymers.

The poly(meth)acrylic latexes include e.g. ethyl(meth)acrylate or butyl (meth)acrylate, or methoxyethyl or ethoxyethyl(meth)acrylate-based latexes. The so called core-shell latexes can also be mentioned, such as those described for example in the French patent application FR 2,790,317.

Latexes based on styrene/(meth)acrylate copolymers include e.g. those marketed by ZENECA RESINS under the trade name NEOCRYL®.

Latexes based on butadiene/(meth)acrylate copolymers include e.g. poly(methylmethacrylate-butadiene) latexes, poly(ethylmethacrylate-butadiene) latexes, poly(propylmethacrylate-butadiene) latexes, poly(butylmethacrylate-butadiene) latexes, poly(methylacrylate-butadiene) latexes, poly(ethylacrylate-butadiene) latexes, poly(propylacrylate-butadiene) latexes, and poly(butylacrylate-butadiene) latexes.

Polyurethane-based latexes are also known and available on the market.

Polyurethane-based latexes that can particularly be mentioned are those described in the European patent EP 0,680,492.

Polyurethane-based latexes are marketed for example by BAXENDEN under the trade names W-240 and W-234, or by ZENECA RESINS under the trade name NEOREZ®.

Generally, the initial latex has a dry matter content ranging from 20 to 50% by weight.

As used herein, the initial latex dry matter content means the weight percentage of solid materials in the initial latex.

Initial latex particles advantageously are particles having sizes of less than 300 nm, preferably of 250 nm or less, and even more preferably of less than 100 nm.

According to a first embodiment, the initial latex is a polyurethane type latex, 95% by weight of which particles are less than 30 nm in size, preferably less than 15 nm and even more preferably less than 10 nm.

According to a second embodiment, the initial latex is an acrylic type latex, more than 70% by weight, preferably more than 80% by weight, of which particles are 250 nm or less in size, and more preferably less than 100 nm and even more preferably, have a size ranging from 20 to 40 nm.

The initial latex preferably has a glass transition temperature Tg of less than 20° C., preferably of less than −20° C., more preferably of less than −30° C., and even more preferably of less than −40° C.

The initial latex may also comprise at least one anionic or non ionic surfactant.

Anionic surfactants that can be used may be selected from sodium dodecylsulfate, sodium dodecylbenzene sulfonate, sodium dodecylnaphthalene sulfate and polysiloxanes.

As previously explained, the colored latex according to the invention comprises, in addition to an uncolored initial latex, at least one initial aqueous dispersion of at least one pigment, the one or more pigment(s) being water-insoluble and having a particle mean size of less than 200 nm.

Preferably, the one or more pigment(s) has or have a particle mean size of less than 150 nm, more preferably of less than 100 nm.

Selecting such pigments, notably what concerns the particle size, makes it possible to suitably disperse the pigments into the initial latex, as well as to obtain a good stability (with no flocculation).

Moreover, those pigments are not released in soda or alcohols.

In addition, they do present good results in the light fastness standardized test (XBO).

They do finally have the advantage of being finely dispersed and thus of being able to form coatings with a reduced diffusion.

Moreover, the color choice and the color intensity of the colored latex may be obtained by selecting the one or more pigment initial aqueous dispersion(s) and by selecting their amount in the colored latex.

Generally, the one or more initial aqueous dispersion(s) comprise(s) from 10 to 50% of the one or more pigment(s) as related to the total weight of the initial aqueous dispersion (or of each of the initial aqueous dispersions).

The one or more pigment initial aqueous dispersion(s) preferably do or does account for at most 10%, preferably for at most 5%, by weight as related to the weight of the colored latex.

As pigment initial aqueous dispersions that can be suitably used in the colored latex according to the invention, there can be mentioned the quinacridone CI 122 marketed by TOYO under the trade name LIOJET MAGENTA, the phthalocyanine CI 15 marketed by TOYO under the trade name LIOJET CYAN, the isoindolinone CI 110 marketed by TOYO under the trade name LIOJET YELLOW, the inorganic CI 7 marketed by TOYO under the trade name LIOJET BLACK, the phthalocyanine marketed by CLARIANT under the trade name COLANYLBLUE A2R100, the mono-azonaphthol AS marketed by CLARIANT under the trade name COLANYL REDFGR130, the quinacridone marketed by CLARIANT under the trade name HOSTAFINE MAGENTA, the carbon-based pigment dispersion marketed by CLARIANT under the trade name HOSTAFINE BLACK T, the carbon-based dispersion marketed by CLARIANT under the trade name HOSTAFINE BLACK TS, the phthalocyanine marketed by CLARIANT under the trade name HOSTAFINE BLUE B2G, the phthalocyanine marketed by CLARIANT under the trade name HOSTAFINE GRENNGN, the HOSTAFINE YELLOW HR diarylide.

It is a further object of the present invention to provide a method for preparing a colored latex such as previously defined, said method comprising a step consisting in mixing the initial latex with the one or more pigment initial aqueous dispersion(s).

It is another object of the present invention to provide a method for treating a transparent substrate having a front main face and a rear main face, said treating method comprising a step of depositing onto at least one said main face a colored latex layer such as previously defined, followed by at least partially drying said layer.

In the context of the present invention, the substrate is preferably a mineral or an organic glass, preferably an organic glass.

Organic glass-based substrates may be any organic glass ordinarily used for ophthalmic applications, especially for making ophthalmic lenses.

Substrates that may be suitably treated with the treating method according to the invention include substrates obtained by polymerizing alkyl (meth)acrylates, especially C₁-C₄ alkyl(meth)acrylates, such as methyl (meth)acrylate or ethyl(meth)acrylate, allyl derivatives, preferably aliphatic or aromatic, linear or branched polyol allyl carbonates, thio(meth)acrylates, urethanes, thiourethanes, aromatic polyethoxylated (meth)acrylates, preferably polyethoxylated bisphenolate dimethacrylates, epoxides, episulfides or carbonates, or polycarbonate substrates (PC), especially bisphenol A polycarbonate, polyurethane or polythiourethane substrates.

Polyol allyl carbonates may especially be selected from ethyleneglycol bis(allyl carbonate), diethyleneglycol bis(2-methyl carbonate), diethyleneglycol bis(allyl carbonate), ethyleneglycol bis(2-chloro allyl carbonate), triethyleneglycol bis(allyl carbonate), 1,3-propanediol bis(allyl carbonate), propyleneglycol bis(2-ethyl allyl carbonate), 1,3-butadienediol bis(allyl carbonate), 1,4-butenediol bis(2-bromo allyl carbonate), dipropyleneglycol bis (allyl carbonate), trimethyleneglycol bis(2-ethyl allyl carbonate), pentamethyleneglycol bis(allyl carbonate), and isopropylene bis phenol-A bis (allyl carbonate).

Particularly recommended substrates are those obtained by polymerizing diethyleneglycol bis(allyl carbonate), marketed under the trade name CR 39® by PPG INDUSTRIE (ORMA® lens by ESSILOR).

Of course, substrates may be suitably obtained by polymerizing mixtures of the hereabove monomers.

The substrates may be semi-finished (only one face is moulded or surface-treated and polished to the final geometry) or finished (both faces are moulded or surface-treated and polished to the final geometry).

Drying the colored latex layer is generally conducted at a temperature ranging from 40 to 110° C., preferably at a temperature of about 90° C., for a time period ranging from 5 to 15 minutes, preferably of about 10 minutes, in an oven or under an infrared lamp.

In that case, the drying time does generally vary from 20 seconds to one minute.

Generally, the colored latex layer thickness, once dried, does range from 0.5 to 20 μm, preferably from 1 to 10 μm, more preferably from 5 to 7 μm.

The treating method according to the invention may comprise the step of depositing an uncolored latex layer onto the colored latex layer prior to depositing the coating layer.

In such a case, the colored latex may be any usual latex such as those previously described as uncolored initial latexes.

Advantageously, the treating method according to the invention does comprise a step of depositing onto the colored latex layer (or onto the uncolored latex layer that covers the colored latex layer if necessary) a layer of a coating composition.

According to a particular embodiment of the invention, the coating composition does comprise a swelling agent for the colored latex.

Without wishing to be bound by any theory, the present inventors believe that the latex swelling agent does enable the coating composition, as the case may be and depending on the latex nature, to diffuse deep inside the latex and thus produces an excellent adhesion between the latex layer and the coating.

As used herein, a “composition comprising a swelling agent for the colored latex” means any composition that can produce a swelling of at least 30%, preferably of at least 40%, more preferably of at least 50%, and even more preferably of about 60%, of a 1 μm-thick latex layer, applied onto a neutral support such as a mineral glass plate, after a dipping time of 180 seconds at the ambient temperature (around 20° C.) in the swelling composition.

The 1 μm-thick latex layer was obtained by means of depositing, then drying for 10 minutes at 75° C.

The swelling or the swelling ratio is calculated as follows:
1) the glass plate coated with the hardened film is weighted
   The overall mass mₒ does correspond to

mₒ=m_{glass}+m_{insoluble matter}+m_{soluble matter}
wherein
m_{glass} represents the glass plate mass
m_{insoluble matter} represents the mass of materials that are not soluble in the swelling solvent
m_{soluble matter} represents the mass of film materials that are soluble in the swelling solvent
2) the glass plate coated with the hardened film is dipped into the swelling solvent (dipping for 180 s at 20° C.)
3) after withdrawing the plate out of the swelling solvent and once the latter has dripped off, the plate is weighted.
   The resulting m₁ mass is:

m₁=m_{glass}+m_{insoluble matter}+mₛₒₗᵥₑₙₜ
wherein mₛₒₗᵥₑₙₜ represents the mass of solvent having entered into the film.
4) The plate drying is carried out for 1 hour at 90° C.
5) The dried plate is weighted and a mass m₂=m_{glass}+m_{insoluble matter} is calculated.

The swelling ratio corresponds to the ratio between solvent weight to insoluble matter weight, that is to say: m₁-m₂/m₂-m_{glass}.

As an example, a solvent mixture made of 80% methanol, 10% ethanol and 10% methylethyl ketone does produce a swelling, determined as mentioned hereabove, of about 60%, for the W234 latex.

Generally, the swelling agent is an organic solvent selected from C₁-C₆ alcohols, C₁-C₆ ketones and mixtures thereof.

The applicants did observe that despite the latex high swelling ratio and despite the lack of any chemical bond between the pigment(s) and the latex, no release of the pigment(s) in the coating composition occurs, especially when such composition had been dip-coated.

As a result, the color is not affected by the following coating composition deposition treatment and the durability of the coating composition-containing bath is made longer.

The coating layer may be a layer belonging to an anti-abrasion coating or to an antireflective coating, preferably to an anti-abrasion coating.

The anti-abrasion coatings used according to the invention may be any anti-abrasion coatings that are known in the ophthalmic optics field.

The anti-abrasion coatings that are recommended in the present invention include coatings obtained from silane hydrolyzate-based compositions, especially epoxysilane hydrolyzate compositions, such as those described in the French patent application N^{o} 93,026,49 and in the U.S. Pat. No. 4,211,823. Preferably, anti-abrasion coating compositions comprise an epoxysilane hydrolyzate and a colloidal silicon dioxide and/or a colloidal metal oxide such as TiO₂, ZrO₂, Sb₂O₅, or Al₂O₃.

A preferred anti-abrasion coating composition comprises an epoxysilane and dialkyldialkoxysilane hydrolyzate, colloidal silica and a catalytic amount of aluminium acetylacetonate, the balance being substantially solvents that are classically used for formulating such compositions.

Preferably the hydrolyzate used is a γ-glycidoxypropyl trimethoxysilane (GLYMO) and dimethyl diethoxysilane (DMDES) hydrolyzate.

The anti-abrasion coatings are generally applied by dip-coating or spin-coating.

As already stated, the coating layer may also be a layer belonging to an antireflective coating.

As an example, the antireflective coating may comprise a mono- or multilayered film, made of a dielectric material such as SiO, SiO₂, Si₃N₄, TiO₂, ZrO₂, Al₂O₃, MgF₂ or Ta₂O₅, or mixtures thereof.

It thus becomes possible to prevent the occurrence of a reflection at the lens-air interface.

This antireflective coating is generally applied by vacuum deposition according to any one of the following methods:

1. by evaporation, optionally ion beam assisted evaporation.

2. by ion beam sputtering.

3. by cathode sputtering.

4. by plasma assisted-chemical vapour deposition.

In addition to vacuum deposition, the sol-gel deposition of a mineral layer may also be envisaged (for example from a tetraethoxysilane hydrolyzate).

Should the film comprise a single layer, its optical depth has to be λ/4 (where λ represents a wavelength ranging from 450 to 650 nm).

Should a multilayered film comprise three layers, a combination may be used corresponding to the following optical depths λ/4, λ/2, λ/4 or λ/4-λ/4-λ/4.

Moreover, an equivalent film formed with more layers may be used instead of any number of layers belonging to the three aforementioned layers.

When the coating layer is a layer belonging to an anti-abrasion coating, an antireflective coating layer is advantageously applied onto the anti-abrasion coating layer.

When the coating layer is an antireflective coating layer, an anti-abrasion coating layer is advantageously applied onto the substrate prior to depositing the colored latex layer.

As previously explained, a colored latex layer is applied onto at least one substrate's main face.

According to a first embodiment of the invention, a colored latex layer is only applied onto the rear main face of the substrate.

In such a case, an anti-abrasion coating may be applied onto the front main face of the substrate.

The anti-abrasion coating applied onto the front main face of the substrate may itself be coated with an antireflective coating.

Thus, a substrate may be obtained, the rear main face of which is coated with a colored latex layer of the invention, and optionally with an uncolored latex layer as well, and/or with an anti-abrasion layer and/or an antireflective layer thus forming the stacks such as previously described, the front main face of which is coated with an anti-abrasion layer and with an antireflective layer.

According to a second embodiment of the invention, a colored latex layer is applied onto the front main face and/or onto the rear main face of the substrate.

In such a case, each colored latex layer may itself be coated, according to the stacks such as previously described, with an uncolored latex layer, and/or with an anti-abrasion layer and/or with an antireflective layer.

It is ultimately an object of the present invention to provide an ophthalmic lens comprising a transparent substrate having a front main face and a rear main face, a layer made of a colored latex such as previously defined being deposited onto the front main face and/or the rear main face of the substrate.

The substrate which acts as the base of the ophthalmic lens may of course be any type of substrate that is classically used for ophthalmic applications, such as the substrates as described hereabove.

As well as previously stated, the colored latex layer has a thickness ranging from 0.5 to 20 μm, preferably from 1 to 10 μm, and more preferably from 5 to 7 μm.

The ophthalmic lens according to the invention may be coated, on the front main face and/or on the rear main face of the substrate, with an uncolored latex layer, and/or with an anti-abrasion layer and/or with an antireflective layer, according to the coating stacks such as previously described.

The present invention will be illustrated by means of the following examples.

### EXAMPLE 1

### Formulation of a Grey-Colored Polyurethane Type Latex

A colored latex according to the invention was prepared by mixing an initial latex with three initial aqueous dispersions of pigments.

The initial latex was the W234 latex marketed by BAXENDEN. It is a polyurethane-based latex, the dry matter content of which does account for about 30% by weight, and that has been anionically stabilized.

The pigment initial aqueous dispersions used were as follows:
MAGENTA E VP: dispersion comprising 20% by weight of quinacridone pigments; with a particle mean size of 125 nm;
BLUE B2G: dispersion comprising 40% by weight of phthalocyanine pigments; with a particle mean size of 112 nm;
BLACK T: dispersion comprising 30% by weight of carbon pigments; with a particle mean size of 81 nm.

These dispersions belong to the HOSTAFINE series marketed by CLARIANT.

95.042 g of the W234 latex were weighted in a beaker.

Then, 2.015 g of the MAGENTA E VP dispersion, 1.157 g of the BLUE B2G dispersion and 1.786 g of the BLACK T dispersion were added to the beaker containing the W234 latex (by direct dosing in the beaker):

The whole was agitated on a magnetic plate for 2 hours.

A grey-colored polyurethane type latex according to the invention was obtained, with color class 3 for a latex thickness of 6 μm, that is to say able to generate a color class 3 (relative light transmission factor in the visible range Tv of less than 20%) for glasses coated with such a latex at the specified thickness.

### EXAMPLE 2

### Formulation of a Grey-Colored Acrylic Type Latex

A colored latex according to the invention was prepared by mixing an initial latex with three pigment initial aqueous dispersions.

The initial latex was the NEOCRYL®XK 98 latex marketed by NEORESINS. It is an acrylic copolymer-based latex, the solid content of which does account for 44% by weight.

The pigment initial aqueous dispersions used were the same as those described in example 1.

The initial latex and the pigment initial aqueous dispersions were blended in the same amounts and according to the same procedure as in example 1.

A grey-colored acrylic type latex according to the invention, color class 3 was obtained.

### EXAMPLE 3

### Making a Colored Glass from a Bare Glass

It was an object of the present example to apply a layer of a colored latex of the invention onto a substrate.

The colored latex used was the one described in example 1.

There were two types of substrates to be used, on the one side a CR39®-based substrate and on the other side a polycarbonate-based substrate.

The substrate was a semi-finished or finished, optically surface-treated glass.

The substrate did undergo a surface preparation consisting in cleaning it by means of an aqueous 5% soda solution.

The colored latex was applied onto the substrate by spin-coating, at a rate of 700 rpm for 40 seconds, on the concave face.

The latex layer was then dried by means of an infrared heat treatment and/or in the oven at 90° C. for at most 1 hour (generally for approx. 15 minutes).

The thickness of the applied layer, once dried, was 6 μm+/−0.5 μm.

A color class 3 colored glass was obtained, that is to say having a relative light transmission factor in the visible range Tv of less than 20%.

The colored glass could then be coated with a layer of an uncolored latex and with an anti-abrasion coating layer.

To that end, the colored glass surface did undergo a surface preparation consisting, as was the case hereabove, in cleaning it by means of an aqueous soda solution.

A 1 μm-thick uncolored latex layer was then applied onto each face by dip-coating. The uncolored latex used was the polyurethane-type W234 latex marketed by BAXENDEN.

The uncolored latex was then dried.

The anti-abrasion coating layer was then applied (varnish).

The anti-abrasion coating was prepared according the following method.

80.5 parts by weight of hydrochloric acid 0.1N were dropped into a solution comprising 224 parts by weight of GLYMO and 120 parts by weight of DMDES.

The hydrolyzed solution was agitated for 24 hours at the ambient temperature, then 718 parts of a 30% colloidal silica in methanol, 15 parts of acetylacetonate aluminium and 44 parts by weight of ethylcellosolve were added.

A small amount of a surfactant was then added.

The composition theoretical dry matter content did comprise about 13% solid matter coming from hydrolyzed DMDES.

The thus prepared anti-abrasion coating composition was applied onto each face by dip-coating.

The anti-abrasion coating composition was then polymerized at 100° C. for 3 hours.

Moreover, depositing an antireflective coating under vacuum, for example a 4 layer stack such as ZrO₂/SiO₂/ZrO₂/SiO₂ onto either one and/or both faces of the substrate may be conducted.

It can be observed that the color was not affected by the vacuum deposition of the antireflective coating.

### EXAMPLE 4

### Making a Colored Glass from a Varnished Glass

It was an object of the present example to apply a layer of a colored latex of the invention onto a varnished substrate.

The colored latex used was the one described in example 1.

The substrate used was a thermoplastic polycarbonate-based substrate (bisphenol A polycarbonate).

The substrate was a stock finished glass.

The substrate was then coated on both faces with an anti-abrasion coating layer comprising a hydrolyzate of γ-glycidoxypropyl trimethoxysilane, tetraethoxysilane and colloidal silica in methanol, as well as a suitable catalyst.

The anti-abrasion coating composition was then polymerized at 100° C. for 3 hours.

The thus coated substrate did undergo a surface preparation by CORONA chemical activation (corona discharge).

A layer of a colored latex of the invention was then applied. The colored latex was the same as in example 1.

Deposition did occur by spin-coating, at a rate corresponding to 700 rpm for 40 seconds, onto the concave face of the substrate.

The latex layer was then dried by means of an infrared heat treatment.

The thickness of the applied layer, once dried, was 6 μm+/−0.5 μm.

Another anti-abrasion coating layer was then applied (prepared as indicated in example 3) onto the colored latex layer, the deposition being carried out by spin-coating.

The new anti-abrasion layer was pre-dried by means of an infrared heat treatment, then the anti-abrasion coating composition was polymerized at 100° C. for 3 hours.

The substrate could then be coated on both faces with an antireflective coating, for example a 4 layer stack ZrO₂/SiO₂/ZrO₂/SiO₂.

A color class 3 colored glass was obtained, that is to say having a relative light transmission factor in the visible range Tv of less than 20%.

### EXAMPLE 5

### Color Evaluation for Different Colored Latexes of the Invention

The relative light transmission factor in the visible range Tv as well as the color of some coating stacks were evaluated by means of the CIE L*a*b* color-measuring system.

The colored latexes were obtained by adding the following aqueous dispersions (see table 1) in the W234 latex, first starting with the dispersion used in the greatest amount.

Four colored latexes were prepared (grey class 3 (C3), brown class 3 (C3), grey class 0 (C0), brown class 0 (C0)).

TABLE 1

| | | COLORED LATEX | | | |
|---|---|---|---|---|---|
| | CLARIANT | Grey | Brown | Grey | Brown |
| Color | Dispersion | C3 | C3 | C0 | C0 |
| Magenta | Dispersion % | 2.015 | 0.269 | 0.138 | 0.063 |
| | Dry matter % | 0.887 | 0.118 | 0.061 | 0.028 |
| | Pigment % | 0.403 | 0.054 | 0.028 | 0.013 |
| Blue (1) | Dispersion % | 1.157 | | 0.047 | |
| | Dry matter % | 0.555 | | 0.023 | |
| | Pigment % | 0.463 | | 0.019 | |
| Black (2) | Dispersion % | 1.786 | 2.515 | 0.091 | 0.103 |
| | Dry matter % | 0.750 | 1.056 | 0.038 | 0.043 |
| | Pigment % | 0.536 | 0.755 | 0.027 | 0.031 |
| Yellow | Dispersion % | | 0.013 | | 0.010 |
| | Dry matter % | | 0.006 | | 0.005 |
| | Pigment % | | 0.005 | | 0.004 |

| | | | | |
|---|---|---|---|---|
| Dispersion % total amount | 4.958 | 2.797 | 0.276 | 0.176 |
| Dry matter % total amount | 2.192 | 1.181 | 0.122 | 0.076 |
| Pigment % total amount | 1.402 | 0.813 | 0.074 | 0.047 |

C3: class 3; C0: class 0; (1): blue B2G; (2): black T
Dispersion %: weight percentage of corresponding pigment aqueous dispersion in the colored liquid final W234 latex.
Dry matter %: weight percentage of dry matter from the corresponding pigment aqueous dispersion in the colored liquid final W234 latex;
Pigment %: weight percentage of solid pigments from the corresponding pigment aqueous dispersion in the colored liquid final W234 latex.

As an example, the grey-colored C3 latex was obtained by adding to the W234 latex:

The Magenta dispersion, then

The Black dispersion, and ultimately

The Blue dispersion, in amounts such as indicated in table 1.

The results are given in table 2 hereafter.

TABLE 2

| LATEX | Thickness | Tv % | L | a* | b* |
|---|---|---|---|---|---|
| Brown class 3 | 6.5 μm | 12 | 41.2 | 5.2 | 19.4 |
| Brown class 0 | 6 μm | 81.6 | 92.4 | 1 | 2.1 |
| Grey class 3 | 6 μm | 13.4 | 43.3 | −10.4 | −14.1 |
| Grey class 0 | 6 μm | 78.4 | 91 | 0.4 | −0.7 |

### EXAMPLE 6

### Light Fastness Evaluation for Different Colored Latexes of the Invention

The light fastness was evaluated for different layers of colored latexes applied onto a substrate of the invention.

These measures were made according to the XBO test.

This test consisted in exposing the substrate to a xenon high pressure lamp so as to check whether the transmission variation did not exceed a number of limit values as defined by the standard ISO 8089-3.

The substrate was exposed to a xenon high pressure lamp (450 W, with a stabilized current of 25 A+/−0.2 A) at a distance of 300 mm+/−10 mm from said lamp and for 25 h+/−0.1 h. The temperature was 23° C.+/−5° C.

At the end of the light exposure, the relative light transmission factor in the visible range Tv variation should be of less than:

10% for class 0 and 1 substrates;

20% for class 2, 3 and 4 substrates.

In this example, the substrate used was a polycarbonate-based substrate.

It was coated with a colored latex layer obtained by mixing an initial W234 latex with one of the following pigment initial aqueous dispersions:
BLACK T, marketed by CLARIANT (such as defined in example 1),
the dispersion mixture used in example 1, resulting in a grey color,
Brown, marketed by TOYO, corresponding to a tint material mixture in the form of an aqueous dispersion, at respective concentrations in the latex as follows:

| | |
|---|---|
| Black tint material (black): | 5.425% |
| Yellow tint material (yellow): | 0.185% |
| Magenta tint material: | 0.449% |

(indicated percentages correspond to aqueous dispersion % in the latex).

The latex that had been colored with the BLACK T dispersion was 6 μm thick.

The latex that had been colored with the dispersion mixture giving a grey color was 6.4 μm thick.

The latex that had been colored with the Brown dispersion was 6 μm thick. Moreover, in such a case, the colored latex layer was coated with a layer made of an anti-abrasion varnish (the same as used in example 3) and with an antireflective stack ZrO₂/SiO₂/ZrO₂/SiO₂ applied by vacuum deposition.

Results are given in table 3 hereafter.

TABLE 3

| | Tv prior to | Tv after |
|---|---|---|
| Samples | ageing | ageing |
| BLACK T | 42.8% | 44.1% |
| Grey | 8.4% | 8.3% |
| Brown | 13.2% | 13.3% |

It could be observed that the relative light transmission factor in the visible range Tv variation was very low.

### EXAMPLE 7

### Adherence Measurement for Different Stacks According to the Invention

The adherence of stacks comprising a colored latex and an anti-abrasion coating which were obtained in examples 3 and 4 was measured for stacks without any antireflective coating.

The adherence test was conducted according to standard NF T 30-038, which resulted in a notation ranging from 0 to 5 degrees.

Such test consisted in making cuts in the coating by means of a knife, according to a cross-hatch pattern of cutting lines, in applying onto the thus hatched coating an adhesive tape and in trying to tear out the coating by pulling the tape off.

Should a 0 degree be obtained, the results are considered as being good results, that is to say the edges of the cuts remained perfectly smooth, and not any of the squares they did define got off, even after the coated lens had been dipped into a boiling hot water bath for 30 minutes.

The obtained adhesion scores were 0 after a 30 minute boiling water bath, for examples 3 or 4 as described hereabove.

### EXAMPLE 8

### Abrasion Resistance Measurement

The resistance to abrasion of the coating stack obtained in example 3 was measured, with no antireflective coating, for a polycarbonate-based glass.

Resistance to abrasion was measured using the steel wool test, which consisted in abrading the glass convex treated face with a steel wool in the fiber direction by conducting 5 to- and fro-motions, over a range of movement from 4 to 5 cm, while applying a constant force onto the steel wool (5 kg to, 2.5 kg fro). Glasses did then undergo a visual inspection. Scores were given based on following notation:

0: no scratch observed

1: very slightly scratched glass (from 1 to 5 scratches)

2: slightly scratched glass (from 6 to 20 scratches)

3: moderately scratched glass (from 21 to 50 scratches)

4: strongly scratched glass (more then 50 scratches)

5: bare substrate.

The stacks as described in example 3 obtained score 3.

### Comparative Example 1

### Making a Colored Latex from a Water-Soluble Tint Material

Preparation

A colored latex was prepared by mixing in the initial W234 latex (polyurethane-based latex marketed by BAXENDEN) 1% by weight of the blue TECTILON 4R01 200% tint material marketed by CIBA.

The thus obtained colored latex was spin-coated onto the concave face of an ORMA® lens, then was allowed to dry for an hour in an oven at 90° C. A 6 μm-thick colored latex layer was obtained.

Color

The stack relative light transmission factor in the visible range (Tv) as well as its color were measured by means of the CIE L*a*b* color-measuring system. Following results were obtained:

Tv=56.4

L=79.8

a*=−10.9

b*=−25

Diffusion

The lens diffusion was also measured.

Dipping in Alcohol

In order to simulate the sol-gel varnishing step (alcohol base), the lens was immerged into isopropyl alcohol for 3 nm.

The color was then assessed. It could be observed that the lens did lost its color. The tint material was fully extracted with the alcohol.

### EXAMPLES 9 TO 15 AND COMPARATIVE EXAMPLES 2 AND 3

Colored latexes were prepared by incorporating different pigment aqueous emulsions into a W234 latex, marketed by Baxenden.

The characteristics of the incorporated pigments (especially pigment particle mean size, pigment particle maximum size) are given in table 4 hereafter.

Size values were measured using a Malvern Zetasizer.

The Malvern measurement is a particle size measurement using quasi-elastic scattering of the light or using photon correlation. This measurement relates to particles that are suspended in a liquid. It is based upon the observation of the Brownian motion of particles and of the diffused light from a certain angle.

It makes it thus possible to know the mean size: it is a mean diameter weighted by the diffused intensity (i.e. a monodispersed particle solution having a particle size which would result in a light intensity equal to the whole particles being present). This measurement method also enables to know the particle distribution depending on the particle size.

Orma® ophthalmic glasses resulted from the polymerization of diethylene glycol bis(allyl carbonate) were coated with a colored latex 6 μm-thick coating.

The ophthalmic lenses were then inspected as indicated in the hereunder mentioned visual appearance control test.

The test results are given in table 4.

Opalescence Inspection—Appearance Test:

The inspection was conducted in a M6584 HF control room for color evaluation (size 75×50×98), trade name GAMAIN.

In the control room, the illuminant was d65 and the lighting was 1400 Lux.

Out of the room, the lighting did range from 600 to 1200 Lux.

The inspection occurred on a white background, and the sample was considered as being acceptable if it appeared transparent without any milkiness; it was considered as being opalescent if a haze did affect the light transmittance.

TABLE 4

| | | | | | | Deposition | |
|---|---|---|---|---|---|---|---|
| | | | | | | | Film |
| | Pigment aqueous dispersion | | | Mean size | | Latex | inspection |
| | | | Pigment | Malvern | Maxi | Concen- | using a |
| | | | % | measure- | size for | tration | lamp |
| Example | Trade name | Nature | (3) | ment | 100% | (4) | house |
| 9 | Hostafine | quina- | | | | | Accept- |
| | Magenta | cridone | 20% | 125 nm | 262 nm | 0.3% | able |
| | EVP2609 | | | | | | |
| | (Clariant) | | | | | | |
| 10 | Hostafine blue | phthalo- | 40% | 111 nm | 275 nm | 0.3% | Accept- |
| | B2G (Clariant) | cyanine | | | | | able |
| 11 | Hostafine | carbon | 30% | 83 nm | 242 nm | 0.3% | Accept- |
| | black T | | | | | | able |
| | (Clariant) | | | | | | |
| 12 | Hostafine | diarylide | 35% | 115 nm | 343 nm | 0.3% | Accept- |
| | yellow HR | | | | | | able |
| | (Clariant) | | | | | | |
| Compar- | Hostafine Red | Naphthol | 40% | 156 nm | 377 nm | 0.3% | Opales- |
| ative 2 | HF3S | AS | | | | | cent |
| | (Clariant) | | | | | | |
| Compar- | Hostafine | Naphthol | | | | | Opales- |
| ative 3 | Rubine F6B | AS | 40% | 177 nm | 394 nm | 0.3% | cent |
| | (Clariant) | | | | | | |
| 13 | Liojet yellow | Isoindo- | 10-20% | 70.6 nm | 157 nm | 0.3% | Accept- |
| | (Toyo) | linone | | | | | able |
| 14 | Liojet Cyan | Phthalo- | 10-20% | 101.7 nm | 313 nm | 0.3% | Accept- |
| | (Toyo) | cyanine | | | | | able |
| 15 | Liojet | Quina- | 10-20% | 79 nm | 217 nm | 0.3% | Accept- |
| | Magenta | cridone | | | | | able |
| | (Toyo) | | | | | | |

(3): solid pigment content in the pigment initial aqueous dispersion
(4): pigment initial aqueous dispersion percentage in the W234 colored latex.

It could be seen that Hostafine HF3S and Hostafine Rubine F6B pigment aqueous dispersions were not suitable in the context of the invention.

A size distribution example, as measured using the Malvern apparatus was given for the Clariant Blue B2G pigment:

| Size nm | Population % |
|---|---|
| 67.8 | 1.7 |
| 82.8 | 5.7 |
| 101.2 | 14.3 |
| 123.6 | 23.7 |
| 151 | 33.1 |
| 184.5 | 16.4 |
| 225.4 | 4.9 |
| 275.3 | 0.3 |

1.-43. (canceled)

44. A colored latex comprising a mixture of an uncolored initial latex and at least one initial aqueous dispersion of at least one pigment being under the form of particles, wherein:
the particles of the pigment(s) are water-insoluble; and
at least X % of the particles of the one or more pigment(s) has a particle size L that is 370 nm or less, in the initial aqueous dispersion, X being equal to or greater than 90.

45. The colored latex of claim 44, wherein X is equal to or greater than 95.

46. The colored latex of claim 45, wherein at least X equals 100.

47. The colored latex of claim 44, wherein L≦320 nm.

48. The colored latex of claim 44, wherein the pigment particle mean size in the initial aqueous dispersion is less than 150 nm.

49. The colored latex of claim 44, wherein the one or more pigment initial aqueous dispersion(s) represent(s) at most 10% by weight as related to the weight of the colored latex.

50. The colored latex of claim 44, wherein the initial latex is a latex based on (meth)acrylic polymers, polyurethanes, polyesters, styrene/(meth)acrylate copolymers, or butadiene/(meth)acrylate copolymers.

51. The colored latex of claim 44, wherein the initial latex is a latex based on (meth)acrylic polymers or polyurethane.

52. The colored latex of claim 44, wherein the initial latex has a dry matter content of from 20 to 50% by weight.

53. The colored latex of claim 44, wherein the initial latex particles are particles which size is less than 100 nm.

54. The colored latex of claim 44, wherein the initial latex is a polyurethane type latex, 95% by weight of which particles have a size of less than 15 nm.

55. The colored latex of claim 44, wherein the initial latex has a glass transition temperature Tg of less than 20° C.

56. A method for producing a colored latex of claim 44, comprising a step of mixing the initial latex with the one or more pigment initial aqueous dispersion(s).

57. A method for treating a transparent substrate having a front main face and a rear main face, comprising a deposition step of a colored latex layer of claim 44 onto at least one said main face, followed by at least partially drying said layer.

58. The method of claim 57, wherein the substrate is obtained by polymerizing alkyl (meth)acrylates, allyl derivatives, thio(meth)acrylates, urethanes, thiourethanes, aromatic polyethoxylated (meth)acrylates, epoxides, episulfides or carbonates.

59. The method of claim 57, wherein the colored latex layer has a thickness, once dried, of from 0.5 to 20 μm.

60. The method of claim 57, further defined as comprising a step of depositing onto the colored latex layer a coating composition layer.

61. The method of claim 60, wherein the composition layer comprises a swelling agent for the colored latex.

62. The method of claim 61, wherein the swelling agent is an organic solvent further defined as comprising at least one C₁-C₆ alcohol or C₁-C₆ ketone.

63. An ophthalmic lens comprising a transparent substrate having a front main face and a rear main face, wherein a colored latex layer of claim 44 is applied to the front main face and/or the rear main face of the substrate.

64. The ophthalmic lens of claim 63, wherein the substrate is a mineral or organic glass.

65. The ophthalmic lens of claim 63, wherein the substrate comprises polymerized alkyl(meth)acrylates, allyl derivatives, thio(meth)acrylates, urethanes, thiourethanes, aromatic polyethoxylated (meth)acrylates, epoxides, episulfides or carbonates.

66. The ophthalmic lens of claim 63, wherein the colored latex layer has a thickness of from 0.5 to 20 μm.
